(19) United States
(12) Patent Application Publication
(10) Pub. No.: US 2003/0023877 A1
(43) Pub. Date: Jan. 30, 2003

(54) System and method of managing data transmission loads

(76) Inventors: Michael Luther, Cary, NC (US); David A. Terry, Sunnyvale, CA (US); Humberto M. Tavares, Cary, NC (US)

Correspondence Address: Pillsbury Winthrop LLP, Intellectual Property Group, 50 Fremont Street, San Francisco, CA, 94105, US

(21) Appl. No.: 09/919,457

(22) Filed: Jul. 30, 2001

(51) Int. Cl. G06F 11/30

(52) U.S. Cl. 713/201

(57) ABSTRACT

A system and method of managing transmission loads in a data communication network implement a plurality of data processing modules, such as computer servers, each of which may be responsible for a limited range of data processing tasks. A load manager may distribute incoming data packets in accordance with the particular network transaction with which the data packets are associated as well as the present load at each of the plurality of data processing modules. A dedicated load manager, such as a computer server, may execute a hash function to direct incoming, data traffic and to allocate system resources.

### FIELD OF THE INVENTION

Aspects of the present invention relate generally to managing data traffic transmitted across a communications network, and more particularly to a system and method providing distribution of data packets among a plurality of call control modules.

### DESCRIPTION OF THE RELATED ART

Recent advances in Internet Protocol (IP) data transmission techniques and wireless communications technologies have led to increasing popularity of internet-based telephony and various other packet-switched data communications services. Conventional systems have proposed internet-enabled or web-enabled call interfaces which are capable of managing packet-based voice and data communications. These systems typically enable IP or web communications services through implementation of a call processing server, i.e. server-side call processing hardware and software operative for call initiation and management.

Conventional server-based call processing methods and hardware platforms are often inadequate to accommodate the volume of communications traffic for which the server is responsible. As new users are attracted to the services provided by the current technology, data transmission volume often increases beyond the limits of the network infrastructure employing conventional techniques; consequently, the frequency and magnitude of communication delays due to network traffic continue to worsen.

### BRIEF DESCRIPTION OF THE DRAWINGS

FIG. 1 is a simplified high-level block diagram illustrating a data communication network environment in which a system and method of data traffic load management may be employed.

FIG. 2 is a simplified high-level block diagram illustrating one embodiment of a distributed server arrangement implementing a data traffic load management strategy.

FIG. 3A is a simplified block diagram illustrating the form and composition of one embodiment of a Call Control Server Table.

FIG. 3B is a simplified block diagram illustrating the form and composition of one embodiment of an Active Call Control Server Table.

FIG. 4 is a simplified block diagram illustrating the form and composition of one embodiment of a heartbeat message.

FIG. 5A is a simplified flow diagram illustrating one embodiment of a method of creating an Active Call Control Server Table.

FIG. 5B is a simplified flow diagram illustrating the general operational flow of one embodiment of a system and method of managing data transmission loads.

FIG. 6 is a simplified flow diagram illustrating the general operational flow of another embodiment of a system and method of managing data transmission loads.

### DETAILED DESCRIPTION

Embodiments of the present invention overcome various shortcomings of conventional technology, providing a system and method of managing data transmission loads enabling substantially uniform distribution of incoming data packets among a plurality of data processing modules.

In accordance with one aspect of the present invention, a system and method of load management implement a plurality of call control computer servers, each of which may be responsible for a limited range of data processing tasks. In one embodiment, for example, a load manager may distribute incoming data packets in accordance with the particular network transaction with which the data packets are associated as well as the present load at each of the plurality of call control servers.

In some embodiments, a load management system and method may implement a dedicated load management server employing a hash function to direct incoming data traffic substantially uniformly across a plurality of call control servers. Such distribution of data traffic loads may facilitate optimum allocation of system resources.

The foregoing and other aspects of various embodiments of the present invention will be apparent through examination of the following detailed description thereof in conjunction with the accompanying drawings.

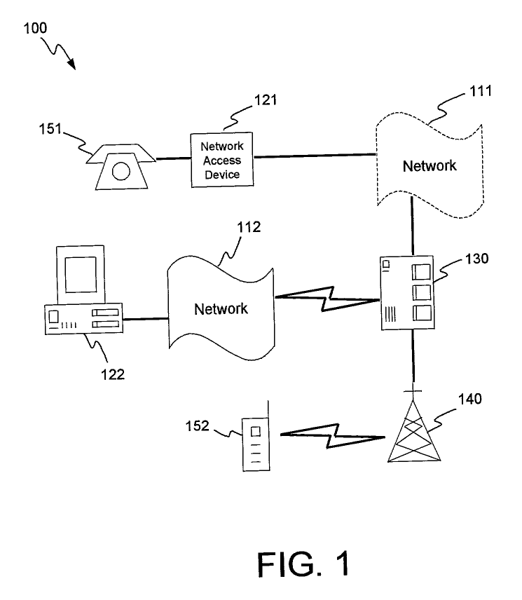

Turning now to the drawings, FIG. 1 is a simplified high-level block diagram illustrating a data communication network environment in which a system and method of data traffic load management may be employed. A communication network 100 may be configured to facilitate packet-switched data transmission of text, audio, video, Voice over Internet Protocol (VoIP), multimedia, and other data formats known in the art. Network 100 may operate in accordance with various networking protocols, such as Transmission Control Protocol (TCP), Internet Protocol (IP), Hypertext Transfer Protocol (HTTP), Simple Mail Transfer Protocol (SMTP), Asynchronous Transfer Mode (ATM), Real-time Transport Protocol (RTP), Real-time Streaming Protocol (RTSP), Session Announcement Protocol (SAP), Session Description Protocol (SDP), and Session Initiation Protocol (SIP). A system and method of managing data transmission loads may be employed in conjunction with numerous other protocols known in the art or developed and operative in accordance with known principles.

Network access devices 121 and 122 may be connected via one or more communications networks 111 and 112 enabling two-way point-to-point, point-to-multipoint, or multipoint-to-multipoint data transfer between and among network access devices 121, 122. Additionally, network access devices 121, 122 may be coupled with peripheral devices such as, inter alia, a telephone 151 or wireless telephone 152. Network access devices 121, 122 and any attendant peripheral devices may be coupled via one or more networks 111, 112 as illustrated in FIG. 1.

For simplicity, data communications such as the foregoing, i.e. involving network access devices 121, 122, may be discussed in the present disclosure with reference to calls. The term “call,” as used herein, may refer to audio transmissions (e.g. voice, digital audio, or telephone signals), video data, text-based services (e.g. “instant text messaging” or “short message service”), multimedia-based messages, or any other packet-based data communication as is known in the art.

Calls may be any real-time or near-real-time audio, video, text, or multimedia-based message transmissions across a computer network (i.e. an “online“ message transmission). Examples of such transmissions include, but are not limited to, user-to-user or user-to-multi-user communications involving electronic conveyance of one or more digital messages such as data packets. Accordingly, examples of calls may include the following: electronic text “chat” or “talk” messaging; electronic mail (e-mail); instant text messaging; video-conferencing; and internet or other IP-based telephony, which may employ VoIP.

In some embodiments, for instance, network access devices 121, 122 may be personal desktop or laptop computers, workstations, personal digital assistants (PDAs), personal communications systems (PCSs), wireless telephones, or other network-enabled devices. The scope of the present disclosure is not limited by the form or constitution of network access devices 121, 122; any apparatus known in the art which is capable of data communication on networks 111 and 112 is within the scope and contemplation of the inventive system and method.

Each individual network 111, 112 may also include or be coupled, either directly or indirectly, to other networkable devices known in the art in addition to telephony infrastructure, such as telephone network server 130 and wireless telephone base station 140. It is well understood in the art that any number or variety of computer networkable devices or components may be coupled to networks 111, 112 without inventive faculty. Examples of other devices include, but are not limited to, the following: servers; computers; workstations; terminals; input devices; output devices; printers; plotters; routers; bridges; cameras; sensors; or any other networkable device known in the art.

Networks 111 and 112 may be any communication network known in the art, including the Internet, a local area network (LAN), a wide area network (WAN), a virtual private network (VPN), or any similarly operating system linking network access devices 121, 122 and similarly capable equipment. Further, networks 111 and 112 may be configured in accordance with any topology known in the art such as, for example, star, ring, bus, or any combination thereof.

In operation, servers, such as telephone network server 130, for example, may be configured to allow two-way data communication between different networks, such as networks 111 and 112 as depicted in FIG. 1. Additionally or alternatively, telephone network server 130 may communicate with a public-switched telephone network (PSTN), plain old telephone service (POTS) network, Integrated Services Digital Network (ISDN), or any other telephone network. As illustrated in FIG. 1, telephone network server 130 may be coupled to wireless base station 140 supporting two-way data communication between telephone network server 130 and wireless telephone 152.

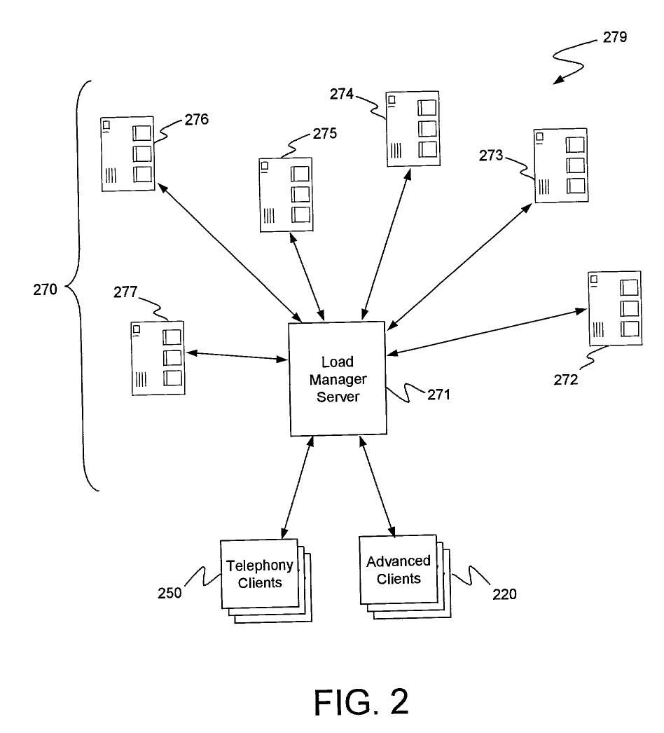

A system and method of managing data transmission loads may be implemented at telephone network server 130, for example, or at one or more physical machines distributed on networks 111, 112. Though a multi-server embodiment is illustrated and described below with reference to FIG. 2, those of skill in the art will appreciate that a load management system and method may be embodied in a single computer server having one or more software programming routines or modules dedicated to load management functionality. The multi-server FIG. 2 arrangement is provided by way of example only, and not by way of limitation.

FIG. 2 is a simplified high-level block diagram illustrating one embodiment of a distributed server arrangement implementing a data traffic load management strategy. The server-side of a network-based communications system may include a distributed computer server arrangement 270 which may generally be constituted by, inter alia, a Load Manager (LM) Server 271 and a Call Control Server Farm 279. As indicated in FIG. 2, Server Farm 279 may generally include a plurality of Call Control (CC) Servers 272-277.

In one embodiment, server arrangement 270 may be characterized as a tiered server platform having a “master” server influencing or managing the operation of one or more “slave” servers, as is generally known in the art. In the FIG. 2 embodiment, for example, LM Server 271 may be configured to act as a master server governing the operation or functionality of the various CC Servers 272-277 in Server Farm 279.

With reference to components illustrated in both FIGS. 1 and 2, it will be appreciated that telephony clients 250 may include telephone 151, wireless telephone 152, a PCS or PDA, and other communication hardware discussed above; additionally, advanced clients 220 may generally correspond to computer-based network access devices 121, 122 discussed above. As noted above, server arrangement 270 may generally be physically situated on, or accessible through, networks 111, 112. In one embodiment, for example, server arrangement 270 may be integrated into a corporate LAN, WAN, or VPN, and have access to data and resources residing on other servers which are part of the network. Data transmission loads and call processing tasks may be distributed by LM Server 271 among the various CC Servers 272-277 such that overall system resources are allocated efficiently.

With respect to server arrangement 270 in general, high availability and scalability may be achieved through the implementation of Call Control Server Farm 279. The arrangement depicted in FIG. 2 is provided by way of example only, and not by way of limitation. For example, server arrangement 270 may be implemented in a single physical machine wherein LM Server 271 and CC Servers 272-277 each may be implemented in the form a dedicated software or firmware module. As another example, while Call Control Server Farm 279 is illustrated as comprising six CC Servers 272-277, those of skill in the art will appreciate that the Server Farm 279 may be scaled to include any number of such CC Servers or software modules without inventive faculty.

In one embodiment, each CC Server 272-277 may host a Connection Logic Control/Session Logic Control (CLC/SLC) pair. As is generally known in the art, the CLC may engage in basic processing of data messages and network transactions, such as handling call setup and call tear-down, for example; the SLC may manage more advance processing related to the call, such as identifying recipients and resolving packet destinations, as well as handling advanced features such as call forwarding, call blocking, and the like.

As noted above, LM Server 271 may distribute incoming data packets, such as SIP messages, for example, substantially evenly or uniformly among CC Servers 272-277 in Server Farm 279. In turn, each CC Server 272-277 may apprise LM Server 271 concerning its current load status and residual processing capacity; firmware and load management software program logic, for example, at LM Server 271 may optimize system resources across the entire Server Farm 279.

Server arrangement 270 be provided with a single IP address for access by clients 220 and 250; in the FIG. 2 embodiment, for example, LM Server 271 may represent a single IP address for the entire server arrangement 270 with respect to the rest of the network universe. In other words, one IP address for LM Server 271 may effectively become the IP address of the entire range of CC Servers 272-277 in the Call Control Server Farm 279 as well.

In this embodiment, LM Server 271 may receive all inbound data transmissions destined for data processing; in packet-switched data communications networks, such data transmissions may comprise data packets, such as SIP messages, for example. As noted above, LM Server 271 may selectively distribute incoming data packets across one or more CC Servers 272-277 in accordance with the present load at each CC Server 272-277, for example. To facilitate such distribution, LM Server 271 may execute (or cause to be executed) firmware instructions or software program code operative to monitor the current load status and remaining processing capacity of each CC Server 272-277 in Server Farm 279. By way of example, LM Server 271 may selectively direct new data traffic only to CC Servers 272-277 having sufficient, currently available processing capacity to accommodate the newly directed load.

In the FIG. 2 arrangement, LM Server 271 may be responsible for executing two primary functions: maintaining the number of messages or data packets sent to each CC Server 272-277 relatively even or substantially uniform; and routing all the messages or data packets corresponding to a particular network transaction or data communication to the same CC Server 272-277.

The above-mentioned functions may be achieved, for example, through use of an identifier for each data packet which is unique to the network transaction with which the data packet is associated. For example, the Call ID field of a SIP message may be an appropriate identifier which may be used to index into a randomly dispersed table, as described below. As another example, HTTP packets may contain a similar unique identifier which may be parsed from the packet header.

Where each CC Server is provided with a “CC Server ID” value, for example, or some other unique identifier, use of a hash function may enable consistent calculation of the same CC Server ID value for each message or data packet having a particular Call ID (i.e. related to the same network transaction). In that regard, a hash function may be implemented such that its output range may be selectively greater than the number of active CC Servers in the Server Farm 279. Additionally, hash function output may be input to a modulo function in accordance with the number of active CC Servers in the Server Farm 279. In the foregoing manner, every data packet having a particular value in the Call ID field may be forwarded to the same CC Server 272-277.

Further, since the current load capacity at each CC Server 272-277 is monitored as described below, data packets related to new network transactions may be distributed such that each CC Server 272-277 in Server Farm 279 may experience a substantially uniform data traffic load relative to every other CC Server 272-277.

In operation, each CC Server 272-277 may use broadcast messages, for example, to notify the system and LM Server 271 of its present load status and residual processing capacity. It will be appreciated that such a broadcast message may employ a common or simple protocol such as User Datagram Protocol (UDP), for instance. In this embodiment, LM Server 271 may monitor such broadcast messages to create and to manage a data structure, such as a CC Server Table, for example, containing data related to known CC Servers 272-277. Such a table may have a static size which may be determined when a load management application (resident on LM Server 271, for example, and containing executable load management program instructions) is started or initiated.

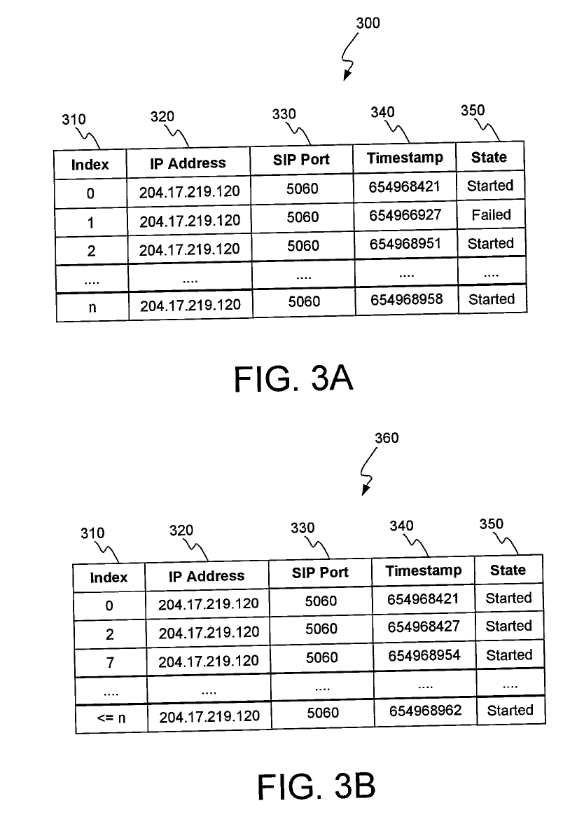

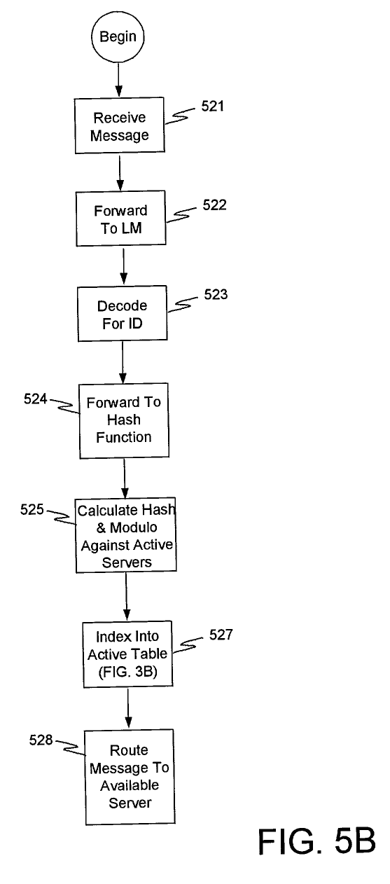

A static table size may generally limit the total number of servers which may be recognized and managed by an executing load management system and method. In an alternative embodiment, a dynamic table of known servers may be maintained to support desired scalability and fault tolerance; for example, a dynamic table of servers known to be active or responsive may be maintained as set forth in detail below with reference to FIGS. 3B and 5A.

A system and method of managing data transmission loads may employ a passive timeout strategy for failing CC Servers 272-277. To support such a timeout strategy, each CC Server 272-277 may be configured with a “heartbeat,” for example; a heartbeat may be a periodic signal which is broadcast or sent at predetermined intervals. That is, an executing CC Server 272-277 may broadcast or send a heartbeat signal at a defined time interval. Each heartbeat signal, in turn, may update a timestamp or counter associated with the server sending the heartbeat signal. Data records related to such timestamps or counters for each known CC Server 272-277 may be maintained at LM Server 271, and may provide an indication of the responsiveness of each CC Server 272-277 in the Server Farm 279.

In this embodiment, load management application software or firmware at LM Server 271 may additionally be configured with a server heartbeat decay value corresponding to the amount of time that a particular CC Server 272-277 may be late in reporting its status. Depending upon overall system configuration, a suitable decay value may be some small multiple (3×-5×, for example) of the server heartbeat period. In conjunction with accessing a CC Server Table entry, for example, the load management software or firmware may check the timestamp associated with each CC Server 272-277; if the timestamp entry is outside of a predetermined range (e.g. above a predetermined threshold), the load management application program may fail the late or non-responsive CC Server 272-277.

One recovery strategy for a failed CC Server 272-277 may be to access the next CC Server 272-277 in the Table. In the case of multiple failed CC Servers, a load management system and method employing this strategy may cascade through a number of failed CC Servers until a valid or operational alternative is found. Failure to find a valid CC Server may result in message loss.

As an alternative, a modified table, for example, derived from the CC Server Table, may contain only active, or currently “good” or responsive, CC Servers. Such an Active table is described in detail below with reference to FIG. 3B; in an embodiment which only accesses such an Active Table, a cascade through one or more failed CC Servers may be avoided, since every CC Server in the accessed Active Table has been confirmed to be responsive.

By way of example only, FIG. 3A is a simplified block diagram illustrating the form and composition of one embodiment of a Call Control Server Table which may be employed by a system and method of managing data transmission loads. Though only one format of CC Server Table 300 is shown, it will be appreciated that different formats may be appropriate, depending, for example, upon the general system configuration, the network communication protocol, or a combination of these and other factors.

The entry in the Index column 310 may represent an identifier for each CC Server in Table 300, such as the CC Server ID value discussed above with reference to FIG. 2. As indicated in the exemplary Table 300, each CC Server may be numbered contiguously, starting at 0. This unique identifier may be used as an entry index into Table 300 for a particular CC Server. Table 300 is illustrated as having a number, n, of entries corresponding to the number of CC Servers in the Server Farm.

The entry in the IP Address column 320 may represent the IP address of the associated CC Server; the IP address may be used to forward any data messages (in this example, SIP messages) intended for a specific CC Server identified by the index field in the Index column 310.

The entry in the SIP Port column 330 may represent the port to which SIP messages bound for a particular CC Server may be directed. The entry in the Timestamp column 340 may represent the system clock time when the last message was received by the associated CC Server. Finally, the entry in the State column 350 may represent the status of the CC Server as reported in its last heartbeat message.

FIG. 3B is a simplified block diagram illustrating the form and composition of one embodiment of an Active Call Control Server Table (Active Table) which may be employed by a system and method of managing data transmission loads. The format and general composition of Active CC Server Table 360 corresponds to CC Server Table 300 shown in FIG. 3A; as noted briefly above, however, Active Table 360 may include only active, or currently “good” or responsive, CC Servers.

The entry in the Index column 310 of Active Table 360 may represent the CC Server ID. An active CC Server may be defined as one with a current time stamp or heartbeat, for example. Accordingly, every entry in the State column 350 in Active Table 360 will be “started,” indicating an active or currently responsive CC Server. Active Table 360 is illustrated as having a number, <=n, of entries; the number of active CC Servers may be less than the total number of CC Servers employed by the system.

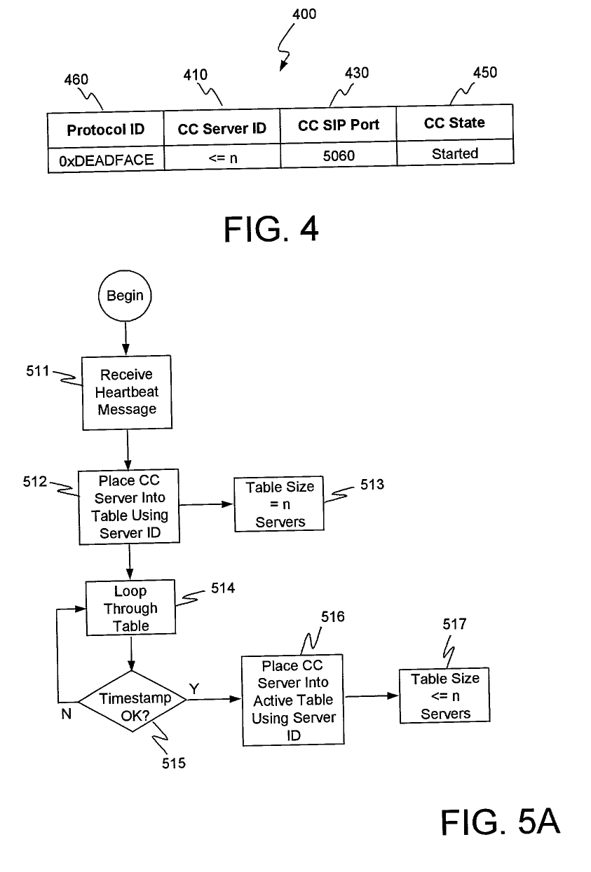

FIG. 4 is a simplified block diagram illustrating the form and composition of one embodiment of a heartbeat message. The CC heartbeat 400 (which may be a UDP Broadcast message as described above, for example) may be in a binary protocol and may contain one or more of the following components: Protocol ID; CC Instance ID; CC SIP Port; and CC State.

In one embodiment, the value in the Protocol ID field 460 may be the same for all heartbeat messages, for example: 0xDEADFACE (where the “0x” prefix is a convention indicating hexadecimal notation). This value may identify the protocol of the heartbeat to the LM Server; such identification may be desirable in the event that another network component sends other types of messages in accordance with a different protocol to the high bandwidth port of the LM Server. The Protocol ID value may also allow load management software or other programming code to identify byte ordering changes.

The value in the CC Server ID field 410 may identify a particular instance of the sending CC Server. Accordingly, this identifier may correspond to the Index field in the CC Server Table and the Active Table, and may facilitate logging of the heartbeat message in the appropriate location in the foregoing tables. The value in the CC SIP Port field 430 may identify the port being used by the sending CC Server for SIP signaling, and may correspond to the SIP Port field in the CC Server Table. Finally, the value in the CC State field 450 may indicate the run state of the sending CC Server, and may correspond to the value in the State columns of the CC Server Table and the Active Table.

As noted above, the LM Server and appropriate load management software resident thereon, for example, may be apprised of the condition and status of each CC Server in the Server Farm through, among other things, receipt of broadcast heartbeat messages from all CC Servers. In operation, the LM Server and its firmware and software components may decode a received heartbeat message and update the CC Server Table row indicated by the heartbeat message CC Server ID field 410; the IP address, SIP Port, and State information in the appropriate row of the CC Server Table may be updated with the appropriate information decoded from the heartbeat message. Additionally, the timestamp field in the CC Server Table may be updated using, for example, the LM Server system clock time.

FIG. 5A is a simplified flow diagram illustrating one embodiment of a method of creating an Active Call Control Server Table such as depicted in FIG. 3B. A heartbeat message is received by an load management server or module at block 511; as described in detail above, a heartbeat message may generally contain a data field for identifying the CC Server from which the heartbeat originates (in this example, such a data field may be the CC Server ID 410 as illustrated in FIG. 4). A system and method of load management may use the CC Server ID to enter the CC Server into the CC Server Table (block 512). As indicated at block 513, the CC Server Table may grow to a size, n, equal to the total number of CC Servers in the Server Farm.

As set forth in detail above, heartbeat messages and timestamps may be employed to monitor which CC Servers in the Server Farm are presently responsive or capable of accepting data processing loads. In that regard, a system and method of load management may create an Active Table such as illustrated in FIG. 3B, through successive or iterative examination of the timestamps for each server in the CC Server Table. At each loop through the CC Server Table (block 514), timestamp fields may be inspected and compared to current system time, for example.

At decision block 515, only servers with current timestamps are accepted for the Active Table. A system and method of load management may use the CC Server ID to enter the responsive CC Server into the Active Table (block 516). As indicated at block 517, the Active Table may grow to a size, <=n (i.e. less than or equal to the total number of CC Servers in the Server Farm).

FIG. 5B is a simplified flow diagram illustrating the general operational flow of one embodiment of a system and method of managing data transmission loads. In the FIG. 5B embodiment, all data messages inbound for processing may be received and directed to the LM Server (blocks 521 and 522); this reception and routing of data packets may be supported, for example, through use of a single IP address for the LM Server and the entire Server Farm as described above. The LM Server may decode enough of the data packet or message to ascertain the Call ID or other unique identifier (block 523); as described above with reference to FIG. 2, a unique identifier, such as a Call ID field in a SIP message, may serve as an indication of the network transaction or call with which the particular data packet is associated.

As indicated at blocks 524 and 525, the Call ID or identifier may then be hashed in accordance with an appropriate hash function, the output of which may be supplied to a modulo function which may compute the modulo of the hash results over the number of active CC Servers as described above.

In the FIG. 5B embodiment, the resulting value of the foregoing computations, i.e. the calculated modulo of the hashed CC Server ID, may be used to compute an index for the Active Table described above with reference to FIGS. 3B and 5A. The proper row in the Active Table may then be accessed, and the Table entry corresponding to the correct CC Server may be retrieved (block 527). In some embodiments, once the proper CC Server has been identified and its Active Table entry has been retrieved, load management hardware and software may verify that acceptable values exist in both the Status and Timestamp fields of the CC Server Table; alternatively, such verification may be omitted, since the responsiveness of every CC Server may be confirmed during creation of the Active Table. Finally, at block 528, the LM Server or module may route the data packet or message to the indexed CC Server using IP address and SIP port information specified the appropriate columns for the specific CC Server Table entry.

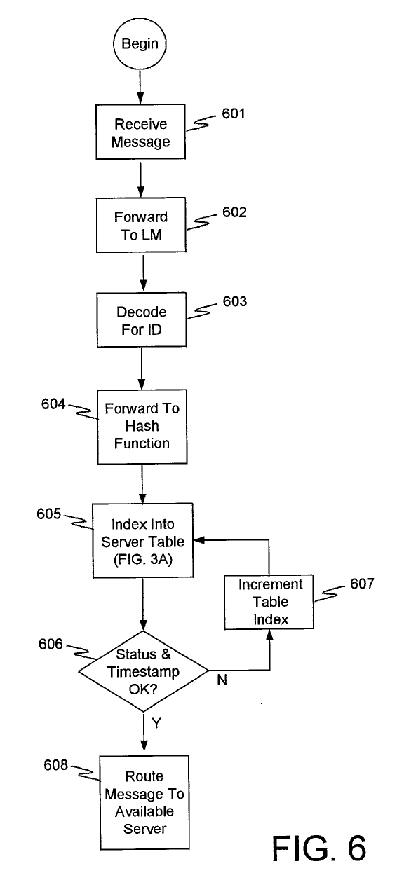

FIG. 6 is a simplified flow diagram illustrating the general operational flow of another embodiment of a system and method of managing data transmission loads. In the FIG. 6 embodiment, the operations depicted at blocks 601-604 may generally correspond to blocks 521-524 described above.

As generally illustrated in FIG. 6, the results of the hash function (or any calculated modulo thereof) may be used to compute an index for the CC Server Table (FIG. 3A) such that the Table entry corresponding to the correct CC Server may be retrieved (block 605). Once the proper CC Server has been identified and its Table entry has been retrieved, load management hardware and software may verify that acceptable values exist in both the Status and Timestamp fields of the CC Server Table for the associated CC Server (decision block 606). Finally, at block 608, the LM Server or module may route the data packet or message to the indexed CC Server using IP address and SIP port information specified in the appropriate columns for the specific CC Server Table entry.

Since the Table indexed at block 605 is the CC Server Table of FIG. 3A (as opposed to the Active Table of FIG. 3B), the verification at block 606 may result in the detection of a failed CC Server based upon unacceptable values in either the Status or Timestamp fields; in other words, an expired Timestamp or a value other than “Started” in the Status field may be interpreted by the system as indicative of a failed CC Server, as described above.

If the Status of the CC Server is not identified as “Started” in the CC Server Table, for example, the LM Server and programming code may route the data packet or message to an alternate CC Server; a load management system and method may increment the Index value (block 607) and loop back to block 605 to identify and to select the next CC Server in the Table. A similar iterative procedure employing blocks 605-607 may be executed if the Timestamp for an identified CC Server is out of range with respect to the configured heartbeat decay value, for example. The data packet or message may be routed to an alternate CC Server selected from the Table in the foregoing manner. Those of skill in the art will appreciate that other methods of identifying an alternate CC Server may be employed.

In accordance with the foregoing, a system and method of data transmission load management may identify an appropriate CC Server to which an incoming message may be routed. In addition, a system and method of load management may employ either of two thread models as described below.

Load management functionally may be implemented in the form of one or more software or firmware load management modules in addition to, or in lieu of, the LM Server described in detail above. In one embodiment, an LM system (whether embodied in processors, storage media, memory, interface cards, and other hardware, or alternatively in server-side load management software and firmware programming instructions) may consists of a single thread, ie. one which may read from both the SIP (or other data) port and the heartbeat port, for example. Data messages may be handled sequentially in the single thread. Heartbeat messages may be employed simply to update fields in the CC Server Table as described in detail above, whereas data messages may cause the LM system to index into the CC Server Table, access data records, and forward each data packet to the proper CC Server.

Those of skill in the art will appreciate that discrepancies in message input rates between the ports may affect overall message throughput in this embodiment. For example, if the rate of message input at one port is significantly different than the rate of message input at the other port, a backlog of messages may develop at the high rate port. Accordingly, under certain circumstances, an LM system responsive to changing load conditions may service one port more frequently than the other. This embodiment may be optimized through use of dynamic port service rate adjustments.

In an alternative embodiment, two separate threads may be created, for example; one thread may be dedicated to heartbeat message handling, while the other thread may be dedicated to data message handling. In systems employing such a dual thread strategy, the CC Server Table may be protected from data corruption through implementation of a mutex (mutual exclusion), preventing simultaneous access of data records in the Table by the multiple threads.

In one embodiment supporting load management redundancy, an LM system may be implemented as a plurality of completely stateless message processors; such a system comprising a number of stateless load managers may employ a load balancing router. The router may accept UDP packets broadcast by each load manager, and may impose a least-cost routing algorithm to balance total system load.

As noted above, a CC Server may host a paired CLC/SLC. Similar to the LM system, the foregoing distributed call control functionality may be implemented in software or firmware call control modules in addition to, or in lieu of, the CC Servers described in detail above. In operation, each call control component, whether embodied in a CC Server or a dedicated call control software module, may reside on a server platform and may be responsible for full processing of data messages in a server-side data processing system.

For load balancing and optimization of system resources, each CC component may periodically report its current load status and residual processing capacity to the LM system, for example, employing a specified heartbeat protocol; additionally or alternatively, each CC component may report on current capacity responsive to queries from the LM system. In this embodiment, a redundant load-balanced LM system may receive broadcast UDP from each CC component or module. Additionally, a CC component may be required to update the “Record Route” and “via” headers for each SIP message directed to the LM system's IP address.

In the case of CC Server or component failure, the LM system may forward remaining messages (for any open transaction on the failed CC Server, for example) to an alternate CC Server in the CC Server Table. In order to accommodate such failures, CC Servers may handle mid-transaction messages (e.g. 200 OK, progress, and the like) at any time. In response to a fail event, the alternate CC Server may act as a pure proxy, simply forwarding messages to the intended destination and logging such messages or data to a Fault, Configuration, Accounting, Performance, and Security (FCAPS) module.

Additionally, an Agent may be associated with each CC Server; in this embodiment, an Agent may be responsible for starting each CC component local to the server on which the Agent is executing. The Agent may autostart the CC component, monitor its process status, and restart the process when it dies.

The present invention has been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A method of managing a data transmission load in a communication network;
said method comprising:
receiving transmitted data at a data transmission load manager;
determining a current data transmission load capacity at each of a plurality of data communication processors;
identifying a network transaction to which said transmitted data is related;
executing a hash function in accordance with said identifying; and
distributing said transmitted data to a selected one of said plurality of data communication processors in accordance with said determining and said executing.

2. The method of claim 1 wherein said receiving includes providing said data transmission load manager with a network address representative of said plurality of data communication processors.

3. The method of claim 1 wherein said identifying includes examining said transmitted data to ascertain an intended recipient.

4. The method of claim 3 wherein said examining includes determining a transaction identification value associated with said transmitted data.

5. The method of claim 1 further comprising:
providing results of said executing to a modulo function; and
computing a modulo value representative of one of said plurality of data communication processors;
wherein said distributing is further in accordance with said computing.

6. The method of claim 4 wherein said determining includes accepting, at said data transmission load manager, one or more load status signals from each of said plurality of data communication processors.

7. The method of claim 6 wherein said distributing is responsive to said transaction identification value and said one or more load status signals.

8. A data transmission load management system comprising:
a plurality of data processors; and
a load manager operative to distribute incoming data to a selected one of said plurality of data processors in accordance with a current data transmission load capacity at each of said plurality of data processors and further in accordance with a network transaction with which said data packet is associated.

9. The system of claim 8 wherein said load manager is provided with a network address representative of said plurality of data processors.

10. The system of claim 8 wherein said load manager is a computer server.

11. The system of claim 10 wherein each of said plurality of data processors is an independent computer server.

12. The system of claim 8 wherein said load manager comprises a hash function providing output associated with said incoming data in accordance with said network transaction.

13. The system of claim 12 wherein said load manager comprises means for identifying an intended recipient of said incoming data and for supplying information related to said intended recipient to said hash function.

14. The system of claim 12 wherein said load manager comprises a function to modulo said output over said plurality of data processors.

15. The system of claim 12 wherein said load manager receives load capacity signals from each of said plurality of data processors.

16. The system of claim 15 wherein said load manager distributes said incoming data responsive to said load capacity signals and said output.

17. A computer readable medium encoded with data and computer executable instructions for managing a data transmission load in a communication network; the data and instructions causing a computer executing the instructions to:
receive transmitted data at a data transmission load manager;
identify a network transaction to which said transmitted data is related;
determine a current data transmission load capacity at each of a plurality of data communication processors;
execute a hash function providing output in accordance with said network transaction; and
distribute said transmitted data to a selected one of said plurality of data communication processors in accordance with said current data transmission load capacity and said output of said hash function.

18. The computer readable medium of claim 17 further encoded with data and instructions, further causing an apparatus to provide said data transmission load manager with a network address representative of said plurality of data communication processors.

19. The computer readable medium of claim 17 further encoded with data and instructions, further causing an apparatus to identify an intended recipient of said transmitted data.

20. The computer readable medium of claim 17 further encoded with data and instructions, further causing an apparatus to determine a transaction identification value associated with said transmitted data.

21. The computer readable medium of claim 20 further encoded with data and instructions, further causing an apparatus to distribute every data packet having a particular transaction identification value to a selected one of said plurality of data communication processors.

22. The computer readable medium of claim 17 further encoded with data and instructions, further causing an apparatus to:
provide said output to a modulo function;
compute a modulo value representative of one of said plurality of data communication processors; and
distribute said transmitted data in accordance with said modulo value.

23. The computer readable medium of claim 17 further encoded with data and instructions, further causing said data transmission load manager to accept a load status signal from each of said plurality of data communication processors.

24. The computer readable medium of claim 23 further encoded with data and instructions, further causing an apparatus to analyze each said load status signal to determine relative residual processing capacity for each of said plurality of data communication processors.

25. A data transmission load management system for use in a packet-switched communications network; said system comprising:
a plurality of data processors; and
a load manager operative to distribute an incoming data packet to a selected one of said plurality of data processors; said load manager comprising:
load determining means for determining current data transmission load capacity at each of said plurality of data processors;
transaction identifying means for identifying a network transaction with which said data packet is associated; and
data distribution means for distributing an incoming data packet to a selected one of said plurality of data processors responsive to said load determining means and said transaction identification means.

26. The system of claim 25 wherein said load manager is provided with a network address representative of said plurality of data processors.

27. The system of claim 25 wherein said load determining means is responsive to load capacity signals from each of said plurality of data processors.

28. The system of claim 25 wherein said transaction identifying means is responsive to a transaction identification value associated with said data packet.

29. The system of claim 28 wherein said load manager distributes every data packet having a particular transaction identification value to a selected one of said plurality of data processors.

30. The system of claim 25 wherein said load manager further comprises a hash function providing output associated with said data packet in accordance with said network transaction.

31. The system of claim 30 wherein said load manager further comprises a function to modulo said output over said plurality of data processors.

32. A packet-switched data communication network comprising:
a plurality of data processors; each of said plurality of data processors having processing capacity, executing data transmission processing tasks, and forwarding data packets to one or more intended recipients; and
a load manager; said load manager operative to identify a network transaction with which transmitted data packets are associated, to receive signals from each of said plurality of data processors related to said processing capacity, and to distribute said data packets to a selected one of said plurality of data processors in accordance with said processing capacity and further in accordance with said network transaction.

33. The packet-switched data communication network of claim 32 wherein said load manager is provided with a network address representative of said plurality of data processors.

34. The packet-switched data communication network of claim 32 wherein said load manager is a computer server.

35. The packet-switched data communication network of claim 34 wherein each of said plurality of data processors is an independent computer server.

36. The packet-switched data communication network of claim 32 wherein said load manager comprises a hash function providing output for each of said transmitted data packets in accordance with said network transaction.

37. The packet-switched data communication network of claim 36 wherein said load manager comprises a function to compute the modulo of said output over said plurality of data processors.

38. The packet-switched data communication network of claim 37 wherein said load manager distributes said data packets responsive to said processing capacity and said modulo.

39. The packet-switched data communication network of claim 32 wherein said load manager distributes said every data packet associated with a particular network transaction to a selected one of said data processors.
